(19) United States
(12) Patent Application Publication
(10) Pub. No.: US 2001/0047915 A1
(43) Pub. Date: Dec. 6, 2001

(54) Brake fluid bleeding apparatus

(75) Inventors: Masaru Takakubo, Kawanishi-shi (JP); Masaharu Kitahara, Himeji-shi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Okatsune Gears Manufacturing Inc., Himeji-shi (JP)

(21) Appl. No.: 09/817,351

(22) Filed: Mar. 27, 2001

(30) Foreign Application Priority Data
May 30, 2000 (JP) 2000-160924
Dec. 21, 2000 (JP) 2000-388830

(51) Int. Cl. B60T 11/00

(52) U.S. Cl. 188/352

(57) ABSTRACT

A brake fluid bleeding apparatus provided with an air cylinder portion which is expandable and contractable, a pedal attachment portion disposed on an end of the air cylinder portion and detachably attached to a brake pedal of an automobile, and a contact piece portion disposed on another end side of the air cylinder portion and contact a fixation portion inside the automobile to position and fix the air cylinder portion. Further, the brake fluid bleeding apparatus is provided with a flexible air pipe portion one of which end portions is connected to an air supplying hole of the air cylinder portion and the other has an open-close valve, and a connecting portion disposed on the other end side of the air pipe portion for connection to an air supplier.

### BACKGROUND OF THE INVENTION

1. Field of the Invention

This invention relates to a brake fluid bleeding apparatus for changing brake fluid in a braking system and removing air in the brake fluid.

2. Description of the Related Art

Conventionally, changing work of brake fluid in a braking system requires at least two workers. That is to say, a brake fluid container is kept inserted to an injection portion of a master cylinder for hydraulic pressure generation, then, one of the two workers sits on the driving seat to stamp a braking pedal, and the other connects a transparent tube for recovering brake fluid to a purge valve near a brake main body portion (a disc brake or a drum brake). After this preparation is completed, old brake fluid is recovered through the transparent tube by opening the purge valve and stamping the braking pedal repeatedly. In this case, air in the brake fluid is visually observed through the transparent tube, and removal of the air is checked thereby.

However, as described above, changing work of brake fluid in a braking system and bleeding require at least two workers. And it is extremely difficult to conduct the work for one worker. This causes low working efficiency in auto-maintenance shops.

It is therefore an object of the present invention to provide a brake fluid bleeding apparatus with which changing brake fluid and bleeding can be easily conducted by one worker.

### BRIEF DESCRIPTION OF THE DRAWINGS

The present invention will be described with reference to the accompanying drawings, in which:

FIG. 1 is a perspective view showing an embodiment of a brake fluid bleeding apparatus relating to the present invention;

FIG. 2 is an explanatory view showing a working state;

FIG. 3 is an explanatory view showing a changing state of brake fluid and a bleeding state;

FIG. 4 is a top view of a principal portion with a partial cross section showing another embodiment of the present invention;

FIG. 5 is a perspective view showing still another embodiment of the present invention;

FIG. 6 is a side view with a partial omission;

FIG. 7 is a top view with a partial omission;

FIG. 8 is a rear view;

FIG. 9A is an explanatory view showing a working state;

FIG. 9B is an explanatory view showing a working state;

FIG. 10 is an explanatory view showing a working state on an automobile of another kind;

FIG. 11 is an explanatory view showing a modification of the working state;

FIG. 12 is a perspective view showing an elastic expansion member; and

FIG. 13 is an explanatory view showing a working state with the elastic expansion member.

### DESCRIPTION OF THE PREFERRED EMBODIMENTS

Preferred embodiments of the present invention will now be described with reference to the accompanying drawings.

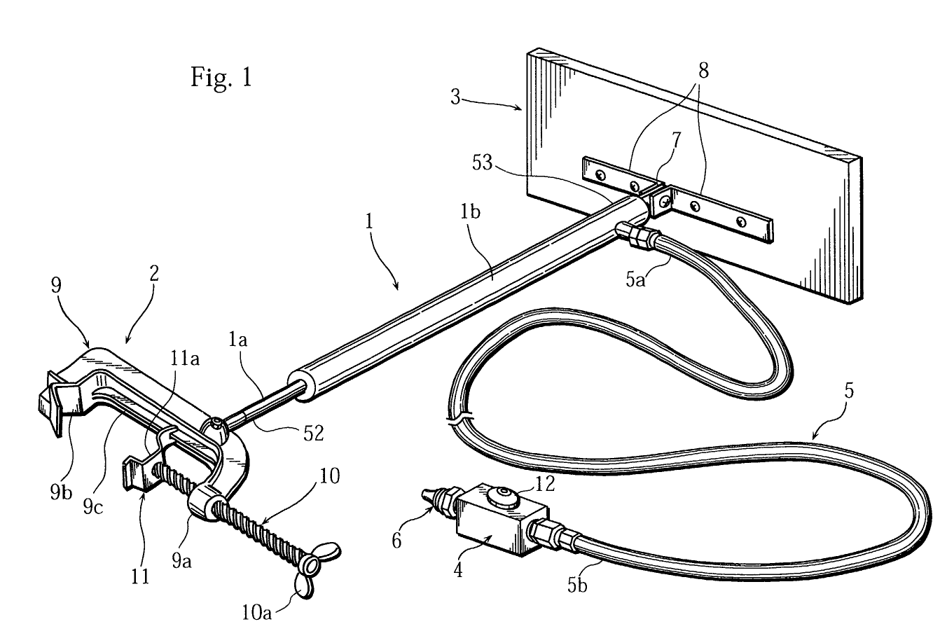

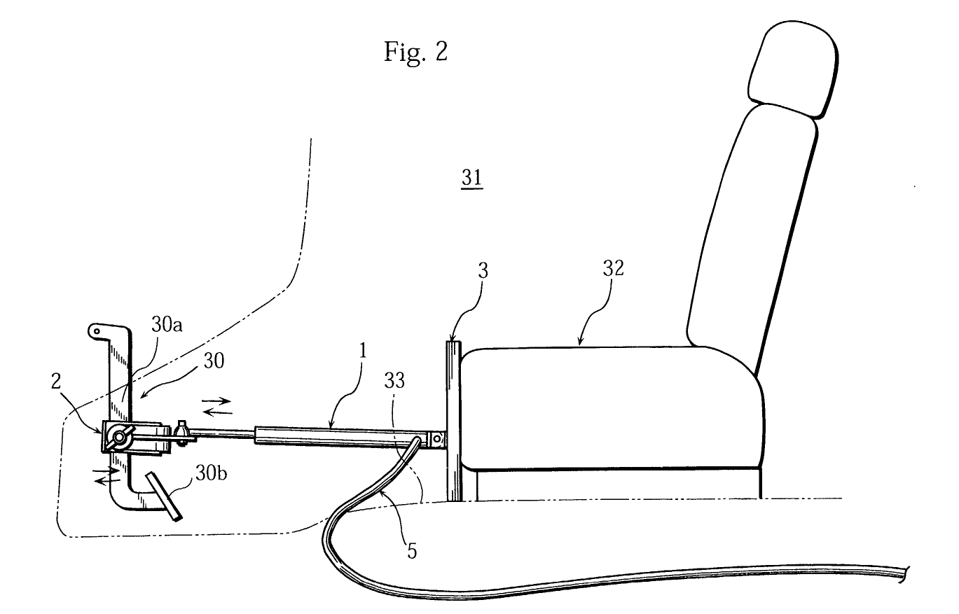

FIG. 1 shows an embodiment of a brake fluid bleeding apparatus relating to the present invention. As shown in FIG. 1 and FIG. 2, this brake fluid bleeding apparatus, which is used for changing brake fluid in a braking system of an automobile and for bleeding, is provided with an expandable air cylinder portion 1, a pedal attachment portion 2 disposed on an end 52 of the air cylinder portion 1 (a forth end of a rod 1a) and releasably holding a brake pedal portion 30 of an automobile, a contact piece portion 3 to position and fix the air cylinder portion 1 by contact with a fixation portion in a passenger room 31 of the automobile, a flexible air pipe portion 5, in which an end 5a is connected to an air supplying hole of the air cylinder portion 1, having an open-close valve 4 on the other end 5b side, and a connecting portion 6 for connection with an air supplier disposed on the other end 5b side of the air pipe portion 5.

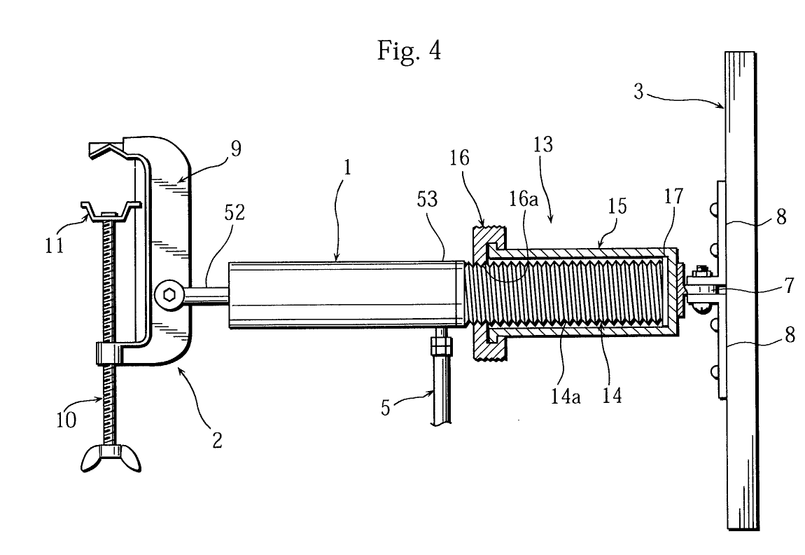

To describe concretely, in the air cylinder portion 1, an attachment protruding piece 7 is disposed on an end of a main body portion 1b, and the attachment protruding piece 7 is attached to one side of the contact piece portion 3 of flat plate through fixation metals 8 as to freely oscillate (refer to FIG. 4). And, although not shown in Figures, the air cylinder portion 1 and the contact piece portion 3 may be connected with a spherical joint.

The pedal attachment portion 2 is, for example, composed of a clamp main body portion 9 of which configuration is approximately C-shaped, having a nut portion 9a on one end side and a concave portion 9b opening to the nut portion 9a side on the other end side, a screw portion 10 having a wing 10a on one end side and screwed to the nut portion 9a, and a pressing piece portion 11 fixed to the other side of the screw portion 10 and having a concave portion 11a facing the concave portion 9b. The clamp main body portion 9 is connected to a forth end of the rod 1a of the air cylinder portion 1 as to freely oscillate. And, a guiding ridge portion 9c is formed on an inner face of the clamp main body portion 9, a concave groove formed on the pressing piece portion 11 is fitted to the guiding ridge portion 9c as to slide to prevent the pressing piece portion 11 from rotating when the screw portion 10 is screwed in and out. With this construction, the apparatus can correspond to an oscillating arm 30a which may have various configurations, and slip, usually generated when a tread face of the pedal 30b is directly pressed by strong force, is not generated.

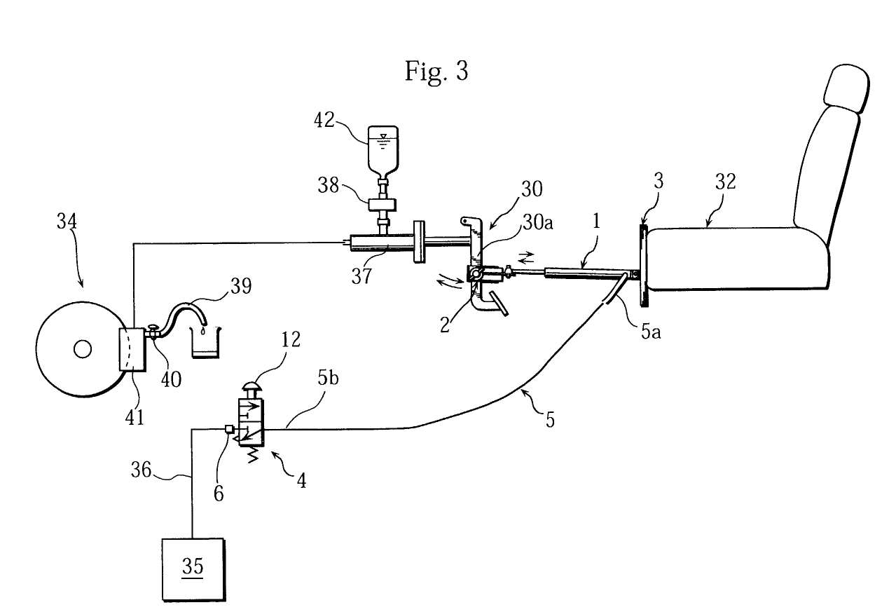

As shown in FIG. 1 and FIG. 3, the open-close valve 4 is, for example, composed of a 3-port 2-position switching valve in which the other end 5b of the flexible air pipe portion 5 and the connecting portion 6 composed of connecting metal are connected to an air flowing passage. And, the open-close valve 4 may be disposed on the air pipe portion 5 on the other end 5b side. In this case, the connecting portion 6 is connected to the other end 5b of the air pipe portion 5.

Next, with reference to FIG. 2 and FIG. 3, changing work of brake fluid and bleeding with the bleeding apparatus is described. First, preliminary preparation is conducted as \mathring{1} through \mathring{5} below.

\mathring{1} A brake fluid container 42 is inserted to an injection portion 38 of a master cylinder 37 and this inserted state is kept.

\mathring{2} A transparent tube 39 is connected to a purge valve 40 of a brake main body 34. That is to say, the transparent tube 39 is connected to a brake caliper 41 in case of a disc brake (shown in FIG. 3), and to a wheel cylinder in case of a drum brake.

\mathring{3} The bleeding apparatus of the present invention is brought into the passenger room 31 and the contact piece portion 3 on the base end side of the air cylinder portion 1 is made contact with a fixation portion in the passenger room 31. In this case, it is preferable to place the contact piece portion 3 on a floor face 33 and made contact with a front end face of a driving seat 32.

\mathring{4} The brake pedal portion 30 is firmly held by the pedal attachment portion 2. That is to say, the oscillating arm 30a of the brake pedal portion 30 is held with the concave portion 9a of the clamp main body portion 9 and the concave portion 11a of the pressing piece portion 11 by fastening the screw portion 10.

\mathring{5} The flexible air pipe portion 5 is drawn out of the passenger room 31 to position the open-close valve 4 near the brake main body portion 34, and connect an air pipe 36 from an air supplier 35 (a compressor) to the connecting portion 6.

The preliminary preparation of the above \mathring{1} through \mathring{5} is not restricted to this order.

After the preparation is completed, one worker near the brake main body 34 opens the purge valve, changes brake fluid (recovers brake fluid) and checks the air removal. That is to say, air is supplied from the air supplier 35 to the air cylinder portion 1 by opening the air flowing passage pushing a push button 12 of the open-close valve 4, the air cylinder portion 1 is expanded (not moved backward by the expansion because the base end side of the air cylinder portion 1 is positioned and fixed) to press the brake pedal portion 30, and old brake fluid is sent out of the master cylinder 37 and new brake fluid from the container 42 is injected. And, when the push button 12 is released, the air supply to the air cylinder portion 1 is stopped, the air cylinder portion 1 is contracted by return movement of the brake pedal portion 30, and air inside the air cylinder portion 1 is exhausted.

As described above, pressing movement of the air cylinder portion 1 to the brake pedal portion 30 is repeated only by repetition of open-close operation of the open-close valve 4 by one worker near the brake main body portion 34, and the brake fluid can be recovered and changed by flowing the brake fluid out of the braking system through the transparent tube 39 on the brake main body 34 side. And, bleeding is visually checked by observation of the air in the brake fluid passing through the transparent tube 39.

Next, FIG. 4 shows another embodiment of the present invention. This brake fluid bleeding apparatus is provided with a length-adjustable expansion mechanism 13 disposed between the other end 53 of the air cylinder portion 1 and the contact piece portion 3.

The expansion mechanism 13 is composed of a screw shaft portion 14 protruding from the other end 53 of the air cylinder portion 1 in an axis direction of the air cylinder portion 1 and having a male screw portion 14a on an outer face, a cylindrical sheath portion 15 of which opening forth end portion is plugged with the screw shaft portion 14 and of which base end is attached to the contact piece portion 3 as to freely oscillate (similar to the attachment construction described with reference to FIG. 1), and a length-adjusting nut portion 16, attached to a forth end of the sheath portion 15 as to be rotatable and having a female screw portion 16a which screws to the male screw portion 14a of the screw shaft 14, on an inner peripheral face.

An outer brim is formed on an opening ridge of the sheath portion 15, a concave groove which fits to the outer brim is formed on a base end side of the inner face of the nut portion 16, and the nut portion 16 is attached as to stop on the forth end of the sheath portion 15 thereby. And, in the nut portion 16, inner diameter of the female screw portion 16a is set to be smaller than inner diameter of the sheath portion 15, and knurled on an outer peripheral face to be easily rotated by hand. And, an outer brim 17 of which diameter is approximately same as the inner diameter of the sheath portion 15 is preferably formed on an end of the screw shaft portion 14 to prevent the screw shaft portion 14 from falling out of the sheath portion 15 and reduce instability between the screw shaft portion 14 and the sheath portion 15.

According to the apparatus composed as described above, whole length of the apparatus can be adjusted by rotating the nut portion 16 of the expansion mechanism 13 to screw the screw shaft portion 14 in and out. Therefore, the apparatus can correspond to automobiles having a relatively small interval between the driving seat 32 and the brake pedal portion 30 (refer to FIG. 2) such as subcompact cars, trucks, etc. with shortening the whole length by contraction of the expansion mechanism 13, and to automobiles having a relatively wide interval between the driving seat 32 and the brake pedal portion 30 such as intermediate cars with extending the whole length by expansion of the expansion mechanism 13. And, the air cylinder portion 1 can be small and having short stroke because the air cylinder portion 1 is required only to press and oscillate the brake pedal portion 30 sufficiently.

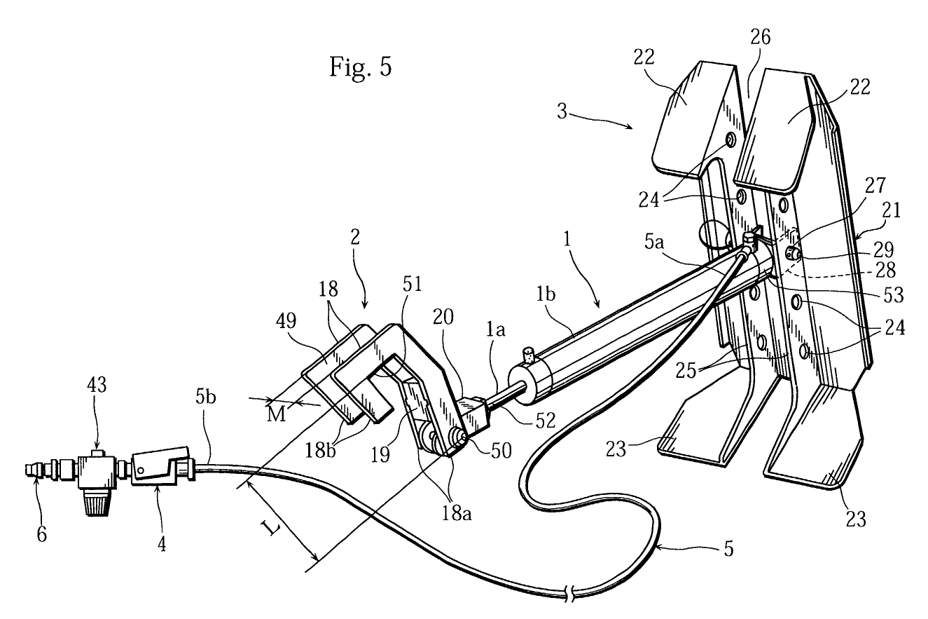

Next, FIG. 5 shows still another embodiment. In this brake fluid bleeding apparatus, having different configurations and constructions of the pedal attachment portion 2 and the contact piece portion 3 from that of the above-described embodiments, the base end of the sir cylinder portion 1 (the other end 53) is detachably attached to the contact piece portion 3 as to change the attachment position.

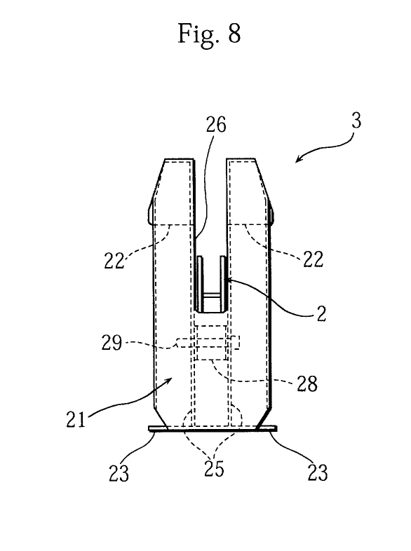

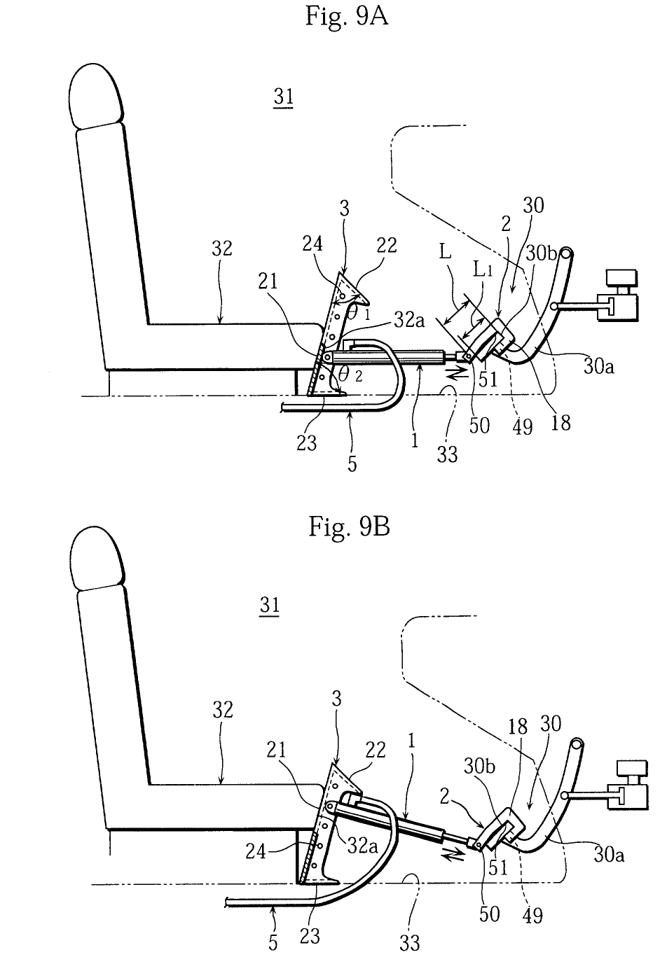

That is to say, as shown in FIG. 5 through FIG. 8, the pedal attachment portion 2 is provided with a pair of hitching piece portions 18 having a configuration of the number 7 facing each other with a gap portion 49 and a connecting portion 19 which connects base ends 18a sides of the pair of hitching piece portions 18, and an approximately U-shaped concave portion 51 is formed on a forth end 18b side of the hitching piece portion 18 having the configuration of the number 7. And, the base ends 18a of the pair of hitching piece portions 18 are attached to an attachment block 20 of a forth end (the end 52) of the air cylinder portion 1 through a bolt as to freely oscillate. In this case, a length dimension L from a bottom face of the concave portion 51 of the hitching piece portion 18 to a bolt fixation portion 50 is set to be larger than a dimension L₁ of the pedal 30b (refer to FIG. 9A) of the brake pedal portion 30, and an interval dimension M of the gap portion 49 between the pair of hitching piece portions 18 is set to be a dimension in which the oscillating arm 30a of the brake pedal portion 30 of various automobiles can be enclosed (a dimension larger than a width dimension of the oscillating arm 30a).

And, the contact piece portion 3 is provided with a vertical contact plate portion 21 which contacts the front end face 32a of the driving seat 32 (refer to FIGS. 9A and 9B) of the passenger room 31, bent pieces 22 formed on one side and upper end of the contact plate portion 21 with an inclination angle θ₁, bent pieces 23 formed on one side and lower end of the contact plate portion 21 with an inclination angle θ₂, a pair of attachment piece portions 25 formed on one side of the contact plate portion 21 in vertical direction and having plural hole portions 24, and a concave portion 26 notched in the contact plate portion 21 between the pair of attachment piece portions 25.

To describe further in detail, each of two pairs of the upper and lower bent pieces 22 and 23 is disposed on the both sides of the pair of attachment piece portions 25 respectively. And, the inclination angle θ₁ of the upper bent piece 22 is, for example, set to be 55° to 65°, and the inclination angle θ₂ of the lower bent piece 23 is, for example, set to be 70° to 80°.

And, the pair of attachment piece portions 25, of which interval dimension is set to be larger than outer diameter of the air cylinder portion 1, of which upper end portions are continuing from the lower faces of the upper bent pieces 22, and of which lower end portions are continuing from the upper faces of the lower bent pieces 23, is formed parallel and protruding forward from one side of the contact plate portion 21. And, the concave portion 26 is notched from an upper or a lower end side of the contact plate portion 21 (an upper end side in this embodiment) to a middle position of the contact plate portion 21.

And, in this bleeding apparatus, a connecting member 28 having a hole portion 27 is attached to the base end (the other end 53) of the air cylinder portion 1, and the base end (the other end 53) of the air cylinder portion 1 is connected to the contact piece portion 3 as to be height-adjustable by correspondence of the hole portion 27 of the connecting member 28 to one desirable pair of hole portions 24 among the plural pairs of hole portions 24 on the attachment piece portions 25 and insertion of a connection pin 29. In the present embodiment, the connecting member 28 is U-shaped opening backward in a top view and having a pair of hole portions 27. And, the connection pin 29 has a stopping protrusion (a ball, for example) which freely protrudes and retreats on an outer peripheral face of a forth end to prevent falling out. Further, as shown in FIG. 5, the flexible air pipe 5 has a pressure-reducing valve 43 between the open-close valve 4 on the other end 5b side and the connecting portion 6 to correspond to a high pressure air supplier.

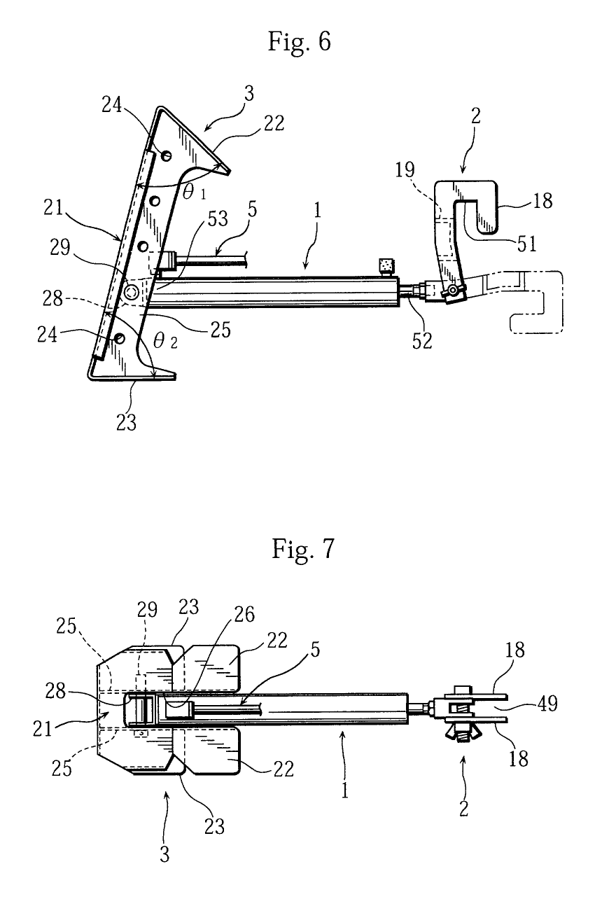

To describe a normal method of use of the brake fluid bleeding apparatus as shown in FIG. 9A, the pair of hitching piece portions 18 of the pedal attachment portion 2 is hitched on the pedal 30b of the brake pedal portion 30 (an upper side of the pedal 30b is fitted to the approximately U-shaped concave portion of the hitching piece portions 18), and the oscillating arm 30a is fitted to the gap portion 49 between the hitching portions 18 to attach the pedal attachment portion 2 to the pedal 30b. With this attachment, the pedal attachment portion 2 does not unexpectedly fall out of the pedal 30b or deviate from the attachment position. On the other hand, the contact piece portion 3 is placed on the floor face 33 with a forward inclination as the contact plate portion 21 contacts the front end face 32a of the driving seat 32. In this case, the inclination angles θ₁ and θ₂ are set as the inclination of the contact plate portion 21 becomes similar to that of the front end face 32a of the driving seat 32. That is to say, the bent pieces 22 or 23 proper to stabilize the contact piece portion 3 are placed on the floor face 33. And, as shown in FIGS. 9A and 9B, height-adjustment is conducted by position change of the connection pin 29 as the base end of the air cylinder portion 1 is positioned on the front end face 32a of the driving seat 32 (refer to FIG. 6) because the height of the driving seat varies according to kinds of the automobile. That is to say, in case that the base end of the air cylinder portion 1 is higher or lower than the front end face 32a of the driving seat 32, the contact piece portion 3 may not be supported by the front end face 32a when the air cylinder portion 1 is expanded, and the contact piece portion may be lifted or upset.

With the setting as described above, (similar to the description with FIG. 3) the flexible air pipe 5 is drawn out of the passenger room 31 to dispose the open-close valve 4 near the brake main body portion 34 and connect the air pipe 36 from the air supplier 35 (a compressor) to the connecting portion 6, the air pressure is, for example, regulated to be 0.4 to 0.6 MPa (preferably 0.5 MPa) with the pressure-reducing valve 43, and repeat pressing movement on the pedal 30b with the air cylinder portion 1 by open-close operation of the open-close valve 4 to change the brake fluid and bleed the air. In this case, the pedal 30b is certainly pushed by the pedal attachment portion 2 because the length dimension L of the pedal attachment portion 2 is larger than the dimension L₁ of the pedal 30b and the bolt fixation portion 50 pushed by the air cylinder portion 1 is on a position on a lower portion of the pedal 30b or lower than the pedal 30b.

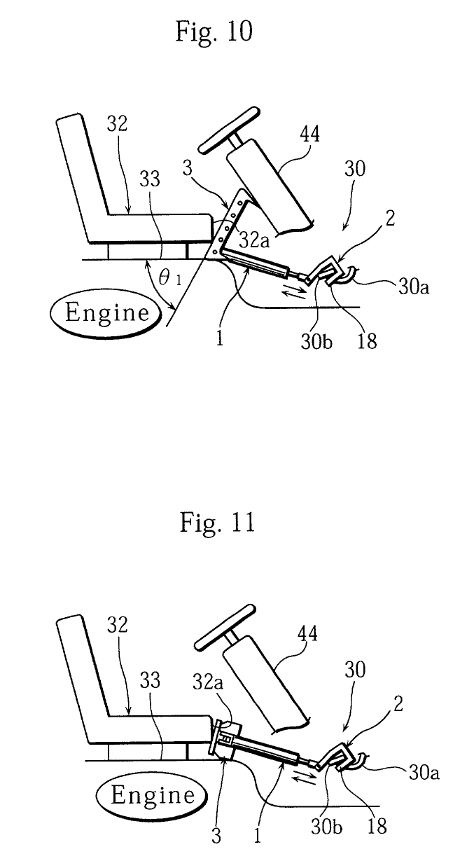

Although a case that the apparatus is used for an automobile having approximately flat floor face 33 (sedans and station wagons, for example) is described in FIGS. 9A and 9B, the apparatus corresponds also to a vehicle having a staged floor face 33 as shown in FIG. 10. That is to say, the floor face 33 is raised for the driving seat 32 in an automobile of which engine is disposed under the driving seat 32 such as a van. In this case, for example, the seat 32 is slid and fixed to a position that the contact piece portion 3 can lean against a steering column 44, and the base end of the air cylinder portion 1 is positioned lower than the seat 32 and the position of the connection pin is fixed. Or, as shown in FIG. 11, the contact piece portion 3 is lain in front of the seat 32, and the position of the connection pin is fixed as the air cylinder portion 1 is approximately at right angles with the contact piece portion 3 (as they form a T in a top view). With this setting, the contact piece portion 3, pressed by the air cylinder portion 1, is supported by the driving seat 32, and the pressing movement to the pedal 30b is certainly repeated.

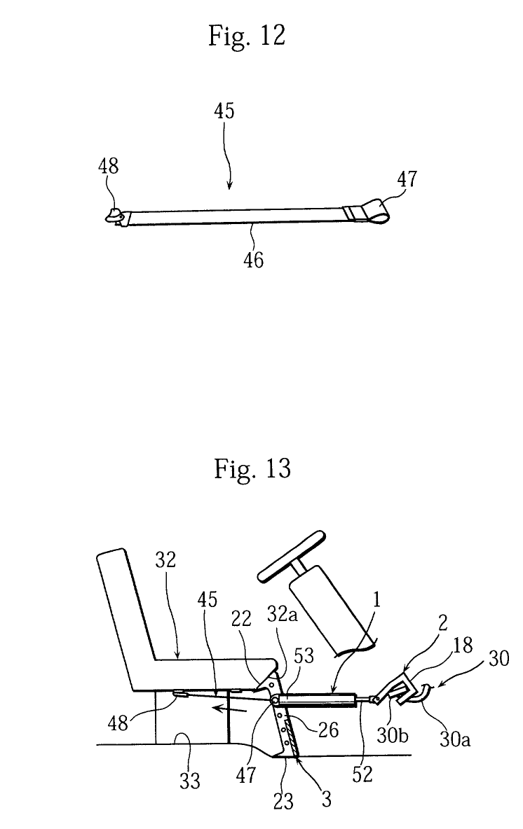

And, the brake fluid bleeding apparatus of the present invention is provided with an elastic expansion member 45 of a belt or a string as shown in FIG. 12. The elastic expansion member 45 is, for example, provided with a belt rubber body 46, a ring portion 47 formed by bending an end of the rubber body 46 and fixed with a fastener, and a hook portion 48 attached to another end of the rubber body 46.

As shown in FIG. 13, the contact piece portion 3 is prevented from falling down by an end of the elastic expansion member 45 connected to the contact piece portion 3 or the other end 53 of the air cylinder portion 1 and another end of the elastic expansion member 45 attached to a lower face side of the driving seat 32 in the automobile. That is to say, the connection pin 29 is inserted to the ring portion 47 and the elastic expansion member 45 is connected to the base end (the other end 53) of the air cylinder portion 1, and the hook portion is lightly pulled and hooked to a wire or other convenient members on the lower face of the seat 32. With this setting, the apparatus is effective in case that can not be treated with normal use because the contact piece portion 3 is pulled backward and certainly prevented from falling down forward. And, as shown in FIG. 13, the apparatus may be placed on the floor face 33 with a backward inclination as the bent pieces 22 and 23 are directed backward and the bent pieces 22 or 23 contact the front end face 32a of the seat 32. In this case, the air cylinder portion 1 can be directed forward through the concave portion 26 formed in the contact piece portion 3.

In the brake fluid bleeding apparatus, not restricted to the embodiments described above, the connecting construction of the elastic expansion member 45 may be modified. For example, a hook portion of wire, formed instead of the ring portion 47 of the elastic expansion member 45, may be hitched to one of the hole portions 24 (refer to FIG. 5) on the contact piece portion 3 on a position of appropriate height.

According to the brake fluid bleeding apparatus of the present invention, the brake pedal portion 30a is repeatedly pushed with the air cylinder portion 1 only by open-close operation of the open-close valve 4 by a worker near the brake main body portion 34, and the brake fluid flown out of the transparent tube 39 on the brake main body portion 34 side is recovered and changed thereby. And, completion of bleeding can be visually checked by observation of the air in the brake fluid which is passing through the transparent tube 39. That is to say, changing the brake fluid and bleeding can be conducted by one worker, and working efficiency in places where these works are frequently conducted such as auto repairing shops, etc. is greatly improved.

And, the pedal attachment portion 2 can be firmly held corresponding to the oscillating arm 30a of the brake pedal portion 30 having various configurations, and slip, usually generated when the tread face of the pedal 30b is directly pressed by strong force, is not generated.

And, length dimension of the whole apparatus can be adjusted. Therefore, the apparatus can correspond to automobiles having relatively small interval between the driving seat 32 and the brake pedal 30 such as subcompact cars and trucks by shortening the whole length with contraction of the expansion mechanism 13, and to automobiles having relatively large interval between the driving seat 32 and the brake pedal 30 such as intermediate cars by lengthening the whole apparatus with expansion of the expansion mechanism 13. And, the air cylinder portion 1 can be small having short stroke because the air cylinder portion 1 is required only to press and oscillate the brake pedal portion 30 sufficiently.

And, the expansion mechanism 13 is strong with a simple construction and easy to make.

And, the pedal attachment portion 2 can be easily attached to and detached from the brake pedal portion 30 of various kinds of automobiles. And, the pedal attachment portion 2 does not deviate from the attachment position on the brake pedal portion 30 and unexpectedly fall out of the brake pedal portion 30.

And, the apparatus can correspond to various kinds of automobiles having various configurations, dimensions, and positional relationships of the driving seat 32 and the floor face 33. And, There is also a merit that the apparatus is made compact by storing the air cylinder portion 1 between the attachment piece portions 25 of the contact piece portion 3 when the apparatus is not in use.

Further, the contact piece portion 3 is certainly prevented from falling down forward when the air cylinder portion 1 is repeatedly expanded and contracted by the elastic expansion member 45. And, the apparatus can be used for automobiles in which normal use of the apparatus is difficult because the contact piece portion 3 can be pulled to the driving seat and fixed by the elastic expansion member 45.

And, the apparatus can be connected without modifications to the air supplier of high pressure because the air pressure can be adjusted to be optimum by the pressure-reducing valve 43.

While preferred embodiments of the present invention have been described in this specification, it is to be understood that the invention is illustrative and not restrictive, because various changes and possible within the spirit and indispensable features.

What is claimed is:

1. A brake fluid bleeding apparatus comprising an expandable air cylinder, a pedal attachment portion on an end of the air cylinder portion and detachably attached to a brake pedal portion of an automobile, a contact piece portion on the other end side of the air cylinder portion for positioning and fixing the air cylinder portion by contact with a fixation portion in a passenger room, a flexible air pipe portion one of which ends is connected to an air supplying hole of the air cylinder portion and having an open-close valve on the other end side, and a connecting portion disposed on the other end side of the air pipe portion and connected to an air supplier, in which;
the brake pedal portion can be repeatedly pressed with the air cylinder portion by supplying air to the air cylinder portion intermittently with open-close operation of the open-close valve conducted near a brake main body of an automobile.

2. The brake fluid bleeding apparatus as set forth in claim 1, wherein:
the pedal attachment portion is provided with an approximately C-shaped clamp main body portion having a nut portion on an end side and a concave portion on the other end side opening to the nut portion side, a screw portion having a wing on an end side and screwed to the nut portion, and a pressing piece portion fixed to the other end side of the screw portion and having a concave portion facing the concave portion of the clamp main body portion; and
the clamp main body portion is attached to the end of the air cylinder portion as to freely oscillate.

3. The brake fluid bleeding apparatus as set forth in claim 1 or claim 2, wherein a length-adjustable expansion mechanism is disposed between a base end of the air cylinder portion and the contact piece portion.

4. The brake fluid bleeding apparatus as set forth in claim 3, wherein the expansion mechanism is composed of a screw shaft portion protruding from the other end of the air cylinder portion in an axis direction of the air cylinder portion and having a male screw on an outer peripheral face, a sheath portion in which the screw shaft portion is inserted to an opening forth end and of which base end is attached to the contact piece portion, and a length-adjusting nut portion attached to a forth end of the sheath portion as to freely rotate and having a female screw on an inner peripheral face screwing to the male screw of the screw shaft portion.

5. The brake fluid bleeding apparatus as set forth in claim 1 or claim 2, wherein the pedal attachment portion is provided with a pair of hitching piece portions having a configuration of the number 7 facing through a gap portion and a connecting portion which connects base ends of the pair of hitching piece portions, and the base ends are attached to the end of the air cylinder portion as to freely oscillate.

6. The brake fluid bleeding apparatus as set forth in claim 1 or claim 2, wherein the contact piece portion is provided with a vertical contact plate portion which contacts a front end face of a driving seat in the passenger room, bent pieces formed on a face side and an upper end of the contact plate portion with an inclination angle, bent pieces formed on the face side and a lower end of the contact plate portion with an inclination angle different from that of the bent pieces of the upper end, a pair of attachment piece portions formed on the face side of the contact plate portion in vertical direction and having plural hole portions, and a concave portion notched between the pair of attachment piece portions, further, a connecting member having hole portions is attached to the other end of the air cylinder portion, the hole portions of the connecting member are made corresponding to desirable hole portions among the plural hole portions of the attachment piece portions, and the other end of the air cylinder portion is connected to the contact piece portion as to be height-adjustable by insertion of a connection pin to the hole portions of the attachment piece portions and the connecting member.

7. The brake fluid bleeding apparatus as set forth in claim 1 or claim 2, wherein an elastic expansion member, one of which ends is connected to the contact piece portion or the other end of the air cylinder portion and the other is attached to a lower face side of the driving seat in the passenger room, is provided to prevent the contact piece portion from falling down.

8. The brake fluid bleeding apparatus as set forth in claim 1 or claim 2, wherein the flexible air pipe portion has a pressure-reducing valve on the other end side.
